(19) United States
(12) Patent Application Publication
(10) Pub. No.: US 2019/0372378 A1
(43) Pub. Date: Dec. 5, 2019

(54) METHOD AND DEVICE FOR REGULATING THE POWER OF AN ELECTRIC CONSUMER

(71) Applicant: Robert Bosch GmbH, Stuttgart (DE)

(72) Inventor: Fritz Kaderabek, Wiener Neudorf (AT)

(21) Appl. No.: 16/461,836

(22) PCT Filed: Oct. 20, 2017
(86) PCT No.: PCT/EP2017/076880

§ 371 Date: May 17, 2019

(30) Foreign Application Priority Data
Nov. 18, 2016 (DE) 10 2016 222 699.1

(51) Int. Cl. H02J 7/00; B60R 16/033; F02B 39/10

(52) U.S. Cl. CPC H02J 7/0063; H02J 2007/0067; F02B 39/10; B60R 16/033

(57) ABSTRACT

The invention relates to a method (400) for regulating the power of an electric consumer (120_1) in an electric system (100) having an electric energy source (160) and at least one first electric consumer (120_1). The energy source (160) has a state of charge. The power demand of the first electric consumer (120_1) in a future time segment is determined (410). The power of the first consumer (120_1) is regulated (420) in the future time segment as a function of the state of charge and of the determined power demand.

### BACKGROUND OF THE INVENTION

The invention relates to a method and a device for regulating the power of an electric consumer in an electrical system of a vehicle, wherein the electrical system comprises an electrical energy source and at least one first electric consumer, and the energy source has a state of charge. The invention further relates to a logic unit and an electrical system, a drive train having a corresponding electrical system, and a computer program and a machine-readable storage medium.

Electrical systems in vehicles comprise electrical energy sources for the supply of at least one or more electric consumers. The energy source of an electrical system has a state of charge, which declines as the operation of the consumers proceeds. Depending upon the power rating of the individual consumers, the state of charge of the energy source declines with varying rapidity. The greater the number of high-power consumers in electrical systems of vehicles, the greater the significance and the necessity of an energy management system for the control and distribution of the electrical energy in the system. Even in the event of the parallel operation or simultaneous switch-on of two high-power consumers, the load capacity of an energy source can be exceeded, thereby resulting in a collapse of the energy supply in the electrical network. An example of two high-power consumers in a vehicle comprises an electrical machine, which supports the drive system of a vehicle, and an electrically powered turbocharger, which compresses the intake air for a conventional combustion engine. Any exceeding of the load capacity of the energy source results in a voltage drop at the consumers, such that intended or required operation of the electric consumers can no longer be guaranteed. In order to prevent the occurrence of such states in electrical systems, solutions are required for the improved regulation of the power of an electric consumer in an electrical system.

### SUMMARY OF THE INVENTION

A method is provided for regulating the power of an electric consumer in an electrical system of a vehicle. The electrical system comprises an electrical energy source and at least one first electric consumer. The energy source has a state of charge. The method comprises the following steps: determination of the power demand of the first electric consumer in a future time segment; regulation of the power of the first electric consumer in the future time segment as a function of the state of charge and of the power demand determined.

A method is provided for regulating the power of an electric consumer. The consumer is part of an electrical system of a vehicle, which comprises an electrical energy source having a state of charge. In the method, the power demand of the first electric consumer in a future time segment is determined. To this end, a means is present which permits the determination of the power demand which will be required by the first electric consumer in a future time segment. As a function of this determined power demand and of the state of charge of the energy source, the power of the first electric consumer in the future time segment is regulated. Advantageously, a method is provided for regulating the power of at least one electric consumer, which ensures intended operation of the at least one consumer in a future time segment.

In a further configuration of the invention, the electrical system comprises the first and a second electric consumer. The power of the second electric consumer, specifically of at least one second electric consumer, is regulated as a function of the residual energy in the electrical system.

An electrical system is provided, which comprises at least the first and a second electric consumer. The first electric consumer is to be operated on a priority basis. This means that the first electric consumer is to be operated at all times as intended, or in accordance with a requirement which is stipulated on the electrical system. At least one second electric consumer, where applicable, can be operated at a power which is lower than the required power. Accordingly, the second electric consumer, specifically, is not operated at all times as intended, or in accordance with a requirement which is stipulated on the electrical system. Intended operation for this first electric consumer receives a higher priority on the grounds that, specifically, the latter is more relevant to operation of an overall system, in which the electrical system is incorporated. The power demand for this first electric consumer in a future time segment is determined. The first electric consumer is regulated in the future time segment as a function of the power demand determined and of the state of charge of the energy source. The at least one second, and consequently lower-prioritized, electric consumer is regulated in accordance with the residual electrical power in the electrical system. This means that the second consumer is not operated in accordance with a requirement dictated by the electrical system, the overall system or a driver, but is operated, where applicable, at a lower power, in accordance with the residual electrical energy or power in the electrical system, in the event of intended operation of the first consumer in the electrical system. For the regulation of the at least one second consumer, the residual electrical energy is preferably determined. Advantageously, a method is provided, in which at least one first electric consumer, which is considered relevant to an overall system, is regulated in accordance with its power demand in the future time segment.

In a further configuration of the invention, the future time segment, for which the power demand of the first consumer is determined, and during which the first consumer is regulated, is defined by a starting time point and a duration. The future time segment has a starting time point which lies in the future, specifically by a few seconds or units of time, for example between 2 and 4 seconds. The future time segment has a duration, which specifically comprises a number of seconds or units of time, for example between 5 and 10 seconds.

The future time segment thus lies in the future, such that an energy management system can prepare for operation in the future time segment. If sufficient energy is not available for the operation of two electric consumers, specifically high-power consumers, the first electric consumer, for example, is operated at the requisite power, and the operation of a second electric consumer is restricted, or even suspended. Advantageously, the intended operation of the first electric consumer is thus ensured.

In a further configuration of the invention, the power demand of the first electric consumer in the future time segment is determined as a function of environmental parameters. Specifically, the power demand of the first electric consumer is determined as a function of operating parameters of a drive train or a combustion engine, or as a function of navigation data.

Determination of the power demand of the first electric consumer in the future time segment is executed as a function of environmental parameters. For example, an electric heater might be operated in response to a low temperature of a drive train, for example in order to permit exhaust gas scrubbing of the exhaust gases from a combustion engine which is to be operated. Alternatively, for example, the power demand of an electrical machine for the start-up of a combustion engine is determined with reference to information to the effect that the combustion engine is to be started up shortly. The power demand of the first electric consumer in the future time segment can likewise be determined as a function of navigation data, for example if a stretch of road with a steep gradient is to be navigated in the future time segment. To this end, for example, an electric turbocharger should be operated, and compress the intake air for the combustion engine, or support an electric drive system of the combustion engine. Advantageously, different criteria are provided for determining the power demand in a future time segment.

In a further configuration of the invention, the first electric consumer is an electric turbocharger. Specifically, the power demand of the first electric consumer is determined, for example, as a function of a target speed and a target pressure of the turbocharger.

In this configuration, the first electric consumer is an electric turbocharger. For the intended operation of the combustion engine, intended operation of the electric turbocharger is required. On the basis of the operating state of a combustion engine, by the modeling of the combustion engine, a target speed and a target pressure for the turbocharger can be determined. Specifically, the power demand of the first electric consumer in the future time segment is determined as a function of this target speed and target pressure. Advantageously, a method is provided for intended operation of a combustion engine and an associated electric turbocharger.

The invention further relates to a computer program, which is designed to execute one of the methods described above.

The invention further relates to a machine-readable storage medium, on which the described computer program is stored.

The invention further relates to a logic unit, wherein the logic unit is designed to determine the power demand of a first electric consumer in a future time segment, as a function of environmental parameters and to provide it in the form of a data record.

A logic unit is provided, which can determine the power demand of a first electric consumer in a future time segment as a function of environmental parameters. This means that the logic unit can receive data, for example from a sensor unit, or from other computing or functional units. As a function of these data, the logic unit determines the power demand of a first electric consumer in a future time segment. The logic unit is moreover designed to provide the power demand determined in the form of information or a data record. The data record is thus made available to a controller, for example a controller of an energy management system. Advantageously, an improved logic unit for an energy management system is provided.

The invention further relates to a device having a described logic unit. This device is specifically the first electric consumer or a control unit.

A device is provided which comprises the described logic unit. The device thus determines the power demand of a first consumer in a future time segment, and provides the latter in the form of a data record. This device can specifically be the first electric consumer. In this case, the first electric consumer is itself capable of communicating its own power demand in a future time segment, for example, to an energy management system. The energy management system can thus regulate and operate the first electric consumer as intended, in the future time segment. Alternatively, the device is a separate control unit, which determines the power demand of a first electric consumer in the future time segment. This information is made available by the control unit to the energy management system for regulating the power of the first electric consumer. For the energy management system, it is immaterial to which functional unit in the electrical system the logic unit is assigned. Advantageously, different variants are provided for the integration of a logic unit, in the interests of an improved energy management system.

The invention further relates to an electrical system having an electrical energy source, at least one first electric consumer, a control unit and a logic unit. The energy source has a state of charge. The logic unit determines the power demand of the first electric consumer in a future time segment. In the future time segment, the control unit additionally regulates, as a function of the state of charge and of the power demand determined, the power of the first electric consumer in the future time segment.

An electrical system is provided, having an electrical energy source, a first electric consumer, a control unit and a logic unit. The function of the logic unit is to determine the power demand of the first electric consumer in a future time segment. The function of the control unit is to regulate the power of the first electric consumer in the electrical system as a function of the determined power demand of the first electric consumer, and of the state of charge of the energy source in the future time segment. Advantageously, an electrical system is provided, in which the intended operation of a first electric consumer is ensured.

The invention further relates to a drive train of a vehicle, having a described electrical system. Specifically, the drive train comprises a combustion engine. A drive train of this type is employed, for example, for the drive of a vehicle which comprises a high-power electrical network or electrical system. Specifically, the drive train comprises an electric turbocharger and/or an electrical machine for the support of the combustion engine drive system. By means of the device and the method, intended operation of the drive train is permitted.

The invention further relates to a vehicle having a described drive train. Advantageously, a vehicle is thus provided which comprises an electrical system having at least one first electric consumer. By means of the method and the device, intended operation of the vehicle is permitted.

It is understood that the characteristics, properties and advantages of the method according to the invention correspondingly apply, or are applicable, to the logic device, to the device or to the drive train, and to the vehicle, and vice versa.

Further characteristics and advantages of forms of embodiment of the invention proceed from the following description, with reference to the attached drawings.

### BRIEF DESCRIPTION OF THE DRAWINGS

The invention is described in greater detail hereinafter, with reference to a number of figures; in the figures:

FIG. 1 shows a schematic representation of an electrical system,

FIG. 2 shows a schematically represented vehicle, having a drive train,

FIG. 3 shows a schematically represented flow diagram of a method for regulating the power of an electric consumer in an electrical system.

### DETAILED DESCRIPTION

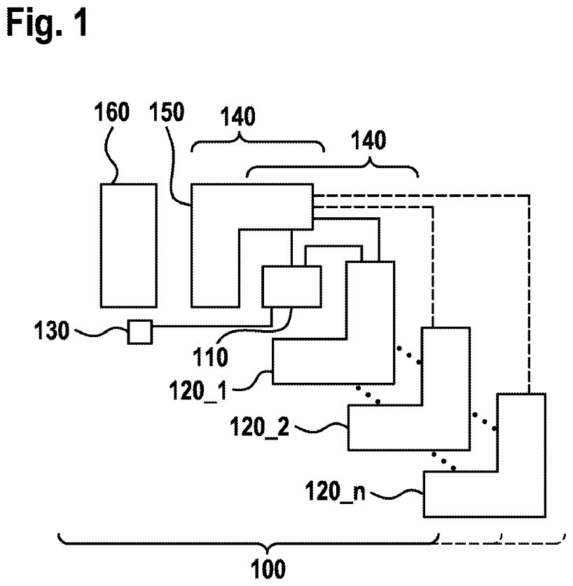

FIG. 1 shows an electrical system 100, having an electrical energy source 160 and at least one first electric consumer 120_1, a control unit 150 and a logic unit 110. The logic unit 110 is designed to determine the power demand of the first consumer 120_1 in a future time segment. To this end, the logic unit 110 receives environmental parameters 130 from a sensor unit or functional unit or, for example, from an operating map. The logic unit 110 provides the determined data with respect to the determined power demand of the first electric consumer 120_1 in a future time segment to the control unit 150 which, in turn, regulates the first electric consumer 120_1 as a function of the determined power demand in the future time segment. In the schematic representation, further potential second electric consumers 120_2 or 120_n are represented, which are also actuated by the control unit 150. However, the actuation of these second electric consumers 120_2, 120_n occurs subsequently to the regulation of the first electric consumer 120_1. The first electric consumer 120_1 is regulated in accordance with the determined power demand and as a function of the state of charge of the energy source 160. Depending upon the residual electrical energy in the electrical system, the downstream second electric consumers 120_2 and 120_n are regulated. The broken line in the figure indicates that the electrical system 100 can specifically comprise a plurality of first and second electric consumers. The device 140 preferably comprises the control unit 150, together with the logic unit 110. The device 140 can preferably also comprise the first electric consumer 120_1, together with the logic unit 110. The logic unit 110 can be configured independently, can be integrated in the control unit 150, can be integrated in the first consumer 120_1, or can be integrated in another functional unit of the electrical system 100.

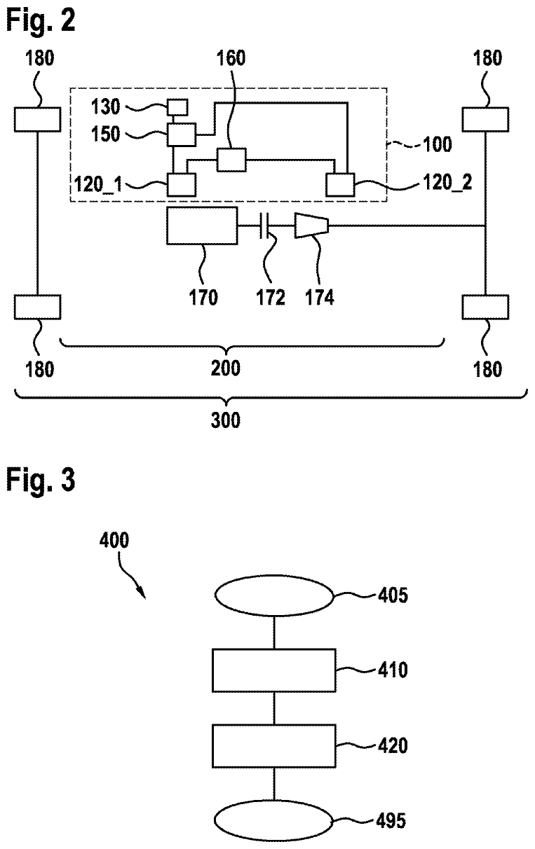

FIG. 2 shows a schematically represented vehicle 300, having a drive train 200. The representation shows an exemplary vehicle having four wheels 180, wherein the invention is equally applicable to any vehicle having any number of wheels, for use on land, in water or in the air. The drive train 200 comprises, for example, a combustion engine drive system having the combustion engine 170, a clutch 172 and a gearbox 174 for driving a vehicle drive axle. The drive train 200 further comprises an electrical system 100 having an energy source 160 for the supply of the at least one first electric consumer 120_1 and preferably at least one second electric consumer 120_2, 120_n. The control unit 150 regulates the power of the first electric consumer 120_1 in a future time segment, and specifically the power of the second electric consumer 120_2, 120_n. To this end, the control unit 150, in addition to the state of charge of the energy source 160 and the determined power demand of the first consumer 120_1 in a future time segment, specifically also considers environmental parameters 130, which are identified by means of appropriate sensors.

FIG. 3 shows a schematic flow diagram of a method 400 for regulating the power of a first electric consumer 120_1 in an electrical system 100. The method commences with step 405. In step 410, the power demand of the first electric consumer 120_1 in a future time segment is determined. In step 420, the power of the first consumer 120_1 in the future time segment is regulated as a function of the state of charge of an energy source 160 and of the power demand determined. The method ends with step 495.

1. A method (400) for regulating a power of an electric consumer (120_1) in an electrical system (100) of a vehicle (300), having an electrical energy source (160) and at least one first electric consumer (120_1),
wherein the energy source (160) has a state of charge;
comprising the following steps:
Determination (410) of a power demand of the first electric consumer (120_1) in a future time segment; and
Regulation (420) of the power of the first electric consumer (120_1) in the future time segment as a function of the state of charge and of the power demand determined.

2. The method (400) as claimed in claim 1,
having a second electric consumer (120_2, 120_n),
wherein a power of the second electric consumer (120_2, 120_n) is regulated as a function of a residual electrical energy in the electrical system (100).

3. The method (400) as claimed in claim 1,
wherein the future time segment is defined by a starting time point which lies in the future, by a few seconds or units of time, and by a duration, which comprises a number of seconds or units of time.

4. The method (400) as claimed in claim 1,
wherein the power demand of the first electric consumer (120_1) in the future time segment is determined as a function of environmental parameters (130).

5. The method (400) as claimed in claim 1,
wherein the first electric consumer (120_1) is an electric turbocharger, and the power demand of the first electric consumer (120_1) is determined as a function of a target speed and a target pressure.

6. A non-transitory machine-readable storage medium comprising a computer program configured to execute the method (400) as claimed in claim 1.

7. (canceled)

8. A logic unit (110), wherein the logic unit (110) is configured to determine the power demand of a first electric consumer (120_1) in a future time segment as a function of environmental parameters (130) and to provide the determined power demand in the form of a data record.

9. A device (140) having a logic unit (110) as claimed in claim 8.

10. An electrical system (100) having an electrical energy source (160), at least one first electric consumer (120_1), a control unit (150) and a logic unit (110) as claimed in claim 8;
wherein the energy source (160) has a state of charge,
the logic unit (110) determines a power demand of the at least one first electric consumer (120_1) in a future time segment,
and the control unit (150) regulates in the future time segment, as a function of the state of charge and of the power demand determined, the power of the first electric consumer (120_1) in the future time segment.

11. A drive train (200) of a vehicle (300), having an electrical system (100) as claimed in claim 10.

12. A vehicle (300) having a drive train (200) as claimed in claim 11.

13. The method (400) as claimed in claim 3, wherein the starting time point of the future time segment lies between 2 and 4 seconds in the future.

14. The method (400) as claimed in claim 3, wherein the duration of the future time is between 5 and 10 seconds.

15. The method (400) as claimed in claim 4, wherein the environmental parameters (130) are a function of operating parameters of a drive train (200).

16. The method (400) as claimed in claim 4, wherein the environmental parameters (130) are a function of a combustion engine (170).

17. The method (400) as claimed in claim 1, wherein the power demand of the first electric consumer (120_1) in the future time segment is determined as a function of navigation data (130).

18. The device (140) as claimed in claim 9, wherein the device is a first electric consumer (120_1).

19. The device (140) as claimed in claim 9, wherein the device is a control unit (150).
